(19) United States
(12) Patent Application Publication
(10) Pub. No.: US 2003/0230123 A1
(43) Pub. Date: Dec. 18, 2003

(54) Firearm lock assembly

(76) Inventor: Adam S. Weinraub, Orange, CA (US)

Correspondence Address: Harold L. Jackson, Jackson Law Corporation, 14751 Plaza Dr., Ste. N, Tustin, CA, 92780, US

(21) Appl. No.: 10/167,834

(22) Filed: Jun. 12, 2002

(51) Int. Cl. E05B 67/06

(52) U.S. Cl. 70/49

(57) ABSTRACT

A lock assembly for deterring the unauthorized access to a firearm includes an elongated cable fixed at one end in a lock housing or an enlarged member. The lock housing is provided with a bore for receiving a free end of the cable. A key lock cylinder is mounted in the housing and includes a rotatable inner cylinder which causes a locking member to engage a groove in the cable free end to secure such end in the lock housing when the inner cylinder is turned by a key to its locked position. Turning the inner cylinder in the opposite direction causes the locking member to be withdrawn from the groove to allow the free end to be withdrawn from the lock housing.

### FIELD OF THE INVENTION

This invention relates generally to firearm safety lock devices and more particularly to cable type locks arranged to extend through the barrel and or the cartridge ejection port.

### BACKGROUND OF THE INVENTION

Thousand of handguns, shotguns and rifles are purchased every year by citizens for use in sporting events, such as hunting or trap and skeet shooting, or for use in home protection. Typically, guns are stored at one's home or apartment in drawers, closets or even under the bed. While a minority of gun owners have gun safes to store their guns, most guns owners store their guns in unlocked areas of the home accessible to others dwelling there. As such, guns provide a danger to children or adolescents whose curiosity may lead them to find and play with a gun. Additionally, a child finding a firearm may take it to show friends or take it to school. While adults may believe that guns are safely put away, children and adolescents always seem to find them, and as a result, fatalities and injuries resulting from the accidental discharge of firearms, particularly by children, has become problematic. Also the intentional use of guns by children against classmates and teachers in schools has been increasing over the last several years. Suicides by use of firearms are also at an alarming rate. In response to the rise of this danger, the US Congress and many state legislative bodies throughout the country have enacted or are in the process of enacting legislation requiring that each new purchase of a gun be accompanied by the purchase of a suitable lock. Additionally, states are creating strict requirements that gun locks must pass to resist tampering and attacks that could disable or remove a gun lock. This is in part a response to the large number of commercially available locks that are of poor quality and unreliable, and the material used to construct certain gun trigger guards that can be easily compromised, allowing the removal of the gun lock.

Gun locks are typically classified into two categories, i.e., trigger locks and cable locks. Trigger locks such as those disclosed in U.S. Pat. Nos. 5,437,119 and 5,918,402 and application Ser. Nos. 09/593,533, 09/871,753 and 10/029,689, assigned to the assignee of this application, have two sides which clamp around the trigger guard of a gun to prevent access to the trigger. While trigger locks, if properly constructed, function as satisfactory determents to the unauthorized use of a firearm, such locks have a drawback of not insuring that a bullet is not present in the chamber of the locked gun.

A typical gun cable lock, as illustrated in FIGS. 1-9, includes an elongated flexible cable 10 which is generally armored, i.e., the individual sockets or links (not shown) are joined together by a twisted wire with the links being made of steel to deter access to the inner wire. The flexible cable is shown in FIG. 1 as being threaded through the barrel 12 of a handgun 14. The fixed end 10a of the cable is secured within a lock housing 16 by means of a sheave 16b wedged within a groove 10b in the fixed end. See FIGS. 2-4. The lock housing is formed from a plurality of steel laminations 16c secured together via rivets 16d and includes a cable free end receiving bore 16e within which is positioned a plunger member 18 biased upwardly by compression spring 20. See FIG. 2. A plastic cover 22 encompasses the sides and a portion of the top and bottom of the housing.

A conventional key cylinder lock 28, mounted in the lock housing, includes a spring biased split tumbler casing 28a and a plug or inner barrel 28b which is rotatable, generally through a 90° angle, with a key 29. The plug 28b is formed with two upwardly projecting spaced posts 28c positioned on the underside 30a of a cam 30 which includes downwardly projecting triangular-shaped stops 30b. Only one of the posts is shown in FIGS. 2-4. The stops 30b are engaged by the posts 28c to rotate the cam to its unlocked position by action of the key 29 as will be explained. An upstanding rib 30c and a short spring retaining rod 30d are formed on the upper surface 30e of the cam. See FIGS. 7 and 8. A spiral spring 32 extends between a center in the rod 30d and a stationary notch 16f in one of the laminated plates, to bias the cam in a counterclockwise direction viewing the top surface of the cam as is illustrated in FIG. 7.

A locking member or bar 34 rides on the upper surface 30e of the cam and is biased toward the bore 16e but prevented from entering the bore by the spring biased plug 18 unless the free end of the cable has depressed the plugnger and placed an annular groove 10c at the cable free or active end 10d opposite the locking member 34. In this case, the locking member is pushed by the rib 30c into the groove via the action of spring 32 to lock the cable free end 10d to the housing.

Some conventional cable locks utilize a ball or plate which is biased toward the cable free end receiving bore by means of a cam and spring or simply by a spring acting directly on the plate. In the later case, the end of the plate adjacent the bore is tapered to allow the cable free end to push the plate out of the bore during cable insertion. In either case a cam like element 30, as shown in FIGS. 6 and 7, is used to couple the rotatable plug or inner barrel 28b to the locking member or plate so that rotation of the key to the unlocked position will move the bar, ball or plate out of the bore occupied by the cable free end thereby allowing the free end to be withdrawn from the lock housing.

Such conventional gun cable locks suffer from several shortcomings. The key can only be withdrawn from the lock when the plug or inner barrel is turned to the locked position. However, the position of the key does not determine whether or not the cable free end, although positioned in the cable receiving bore, is in a locked condition. This is illustrated in FIG. 4 where the lower section 10d of the cable free end, though inserted into the bore engages the locking bar and prevents it from entering the annular groove 10c. Thus, the cable free end may appear to be locked to the housing while it is not. In this condition the lock has failed it's mission.

In addition, the use of a spring to bias a locking member into the cable receiving bore has its own shortcomings. Such a spring must be weak enough to be retracted, e.g., compressed, upon insertion of the cable free end. The mass of the locking member may be sufficient under certain impact conditions, e.g., the firearm being dropped, to cause the spring to retract and release the cable free end. Also springs are subject to fatigue and eventual failure. In addition, it is common knowledge that a spring loaded latch can sometimes be opened by a simple shim.

There is a need for an improved cable gun lock which overcomes the above disadvantages.

### SUMMARY OF THE INVENTION

In accordance with the present invention an elongated cable is provided with a free end adapted to be inserted through a barrel or cartridge ejection port or magazine chamber of a firearm and a fixed end which is not insertable through the barrel or ejection port or magazine chamber. The free end of the cable defines an annular groove. A lock housing has a cable free end receiving bore therein and optionally a bore for receiving and capturing the fixed end of the cable.

A key lock cylinder is mounted in the housing and includes a rotatable plug or inner barrel for receiving and turning through a predetermined angle from a locked position to an unlocked position with a key. The lock cylinder is preferably arranged so that the key can only be withdrawn when the plug is turned to the locked position.

A locking member is coupled directly or indirectly to the plug for movement into and out of the cable free end receiving bore only in response to the rotation of the plug to the locked and unlocked positions, respectively.

The locking member is arranged to extend into the cable free end annular groove when the free end of the cable is inserted a predetermined distance into the bore and the plug is turned to the locked position to thereby lock the free cable end to the housing.

The construction and operation of the invention can best be understood by reference to the following description taken in conjunction with the accompanying drawings wherein like components are given the same reference numeral in the several figures.

### BRIEF DESCRIPTION OF THE DRAWINGS

FIG. 1 is a diagrammatic view of a cable gun lock in use to deny unauthorized access to the firearm;

FIG. 2 is a side elevational view of a prior art cable lock with the free or active end of the cable located outside of a lock housing with the housing shown in a cross-sectional view;

FIG. 3 is a cross-sectional view of the gun lock housing of FIG. 2 with the free end of the cable locked inside the housing;

FIG. 4 is a cross-sectional view of the gun lock housing of FIG. 3 showing the free end of the cable inserted part way into the housing;

FIG. 5 is a cutaway view of the housing taken along lines 5-5 of FIG. 3 showing the position of a locking member and cam in the locked position;

FIG. 6 is a bottom view of the cam of FIG. 5;

FIG. 7 is a top view of the cam of FIG. 5 in the locked position;

FIG. 8 is a top view of the cam in the unlocked position;

FIG. 9 is a top plan view of a spiral spring for biasing the cam and locking member towards the locked position;

FIG. 10 is a top plan view of a cam for modifying the prior art cable lock in accordance with the present invention;

FIG. 11 is a cross-sectional view of a cable and gun lock housing in accordance with the present invention showing the free end of the cable located outside of the housing;

FIG. 12 is a cross-sectional view of the cable lock of FIG. 11 with the free end of the cable in a locked position in the housing and the key partially withdrawn;

FIG. 13 is a cross-sectional view of the cable lock of FIG. 12 with the free end of the cable inserted only part way in the cable receiving bore preventing the cam from entering the cable receiving bore and the key from being withdrawn;

FIGS. 14 and 15 are elevational and top plan views of a conventional key lock cylinder for use in the invention;

FIGS. 16 and 17 are top and bottom plan views of the lock housing of FIGS. 11 and 12;

FIGS. 18 and 19 are bottom plan views of the lock housing of FIGS. 11 and 12, respectively, taken along lines 18-18 and 19-19 in the respective figures showing the condition of the cam in the unlocked and locked positions, respectively;

FIG. 20 is a diagrammatic view of a cable lock with a free end of the cable locked in a lock housing and the fixed or second end secured to an enlarged member for restraining movement of such end through a gun barrel or cartridge ejection chamber;

FIG. 21 is a diagrammatic cross-sectional view of a modified lock arrangement incorporating a key retaining plate for ensuring that the cable free end is in its locked position before the cylinder lock inner barrel can be rotated to its locked position and the key removed;

FIG. 22 is a diagrammatic cross-sectional view of the lock arrangement of FIG. 22 showing the cable free end removed from the lock housing;

FIG. 23 is a diagrammatic cross-sectional view of the modified lock arrangement taken along lines 23-23 of FIG. 21; and

FIG. 24 is a diagrammatic cross-sectional view of the modified lock arrangement taken along lines 24-24 of FIG. 22.

### DESCRIPTION OF THE PREFERRED EMBODIMENTS

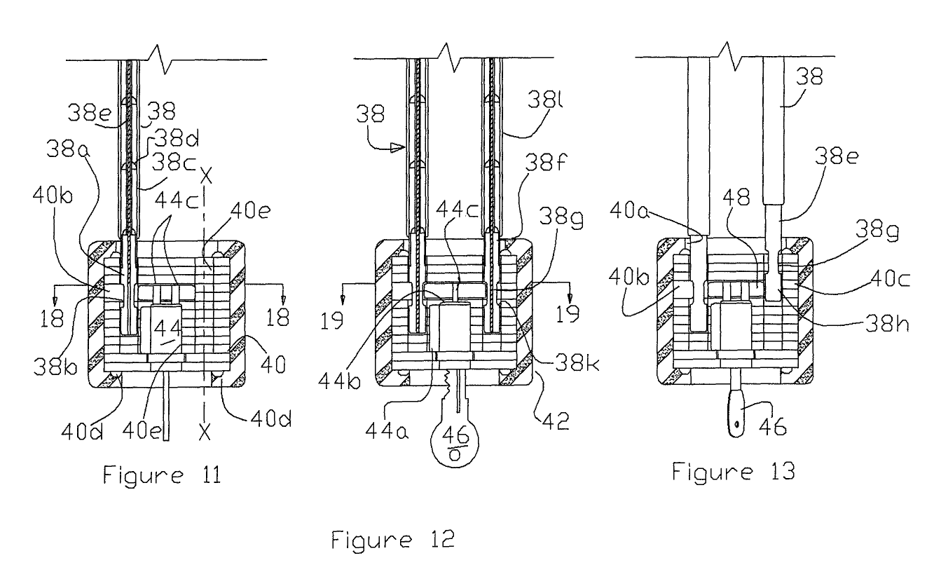

Referring now to the drawings and particularly to FIG. 10 a cam 36 for modifying the prior art cable lock of FIGS. 11 and 12 in accordance with the present invention comprises a pair of symmetrically arranged lobes 36a on the underside of the cam 36. The upper side of the cam may be provided with a rib such as 30c acting on the locking member 34.

The lobes define lock actuating shoulders 36b which are engaged by the plug posts 28c to force the locking member 34 into the groove in the cable free end, thereby locking the cable free end to the lock housing. The cam 36 is shown in the locked position as illustrated in FIG. 7. Since the cam is positively keyed to the plug 28b, the plug can be turned to the locked position (and the key removed) only when the locking member extends into the cable groove with the cable free end being inserted the required or predetermined distance to place the groove opposite the locking member.

The cam 36 also defines unlock actuating shoulders 36c which are engaged by the plug posts 28c to allow the locking member to retract from the cable groove. It is to be noted that the actual rotation of the cam 36 is less than 90°, e.g., about 20°, as is illustrated by the angle [symbol] with the distance between the lock and unlock actuating shoulders allowing the plug to rotate through a preset angle, e.g., about 70°, before the posts engage the opposing actuating shoulders. It should be noted that spring 32 need not be used with the cam 36.

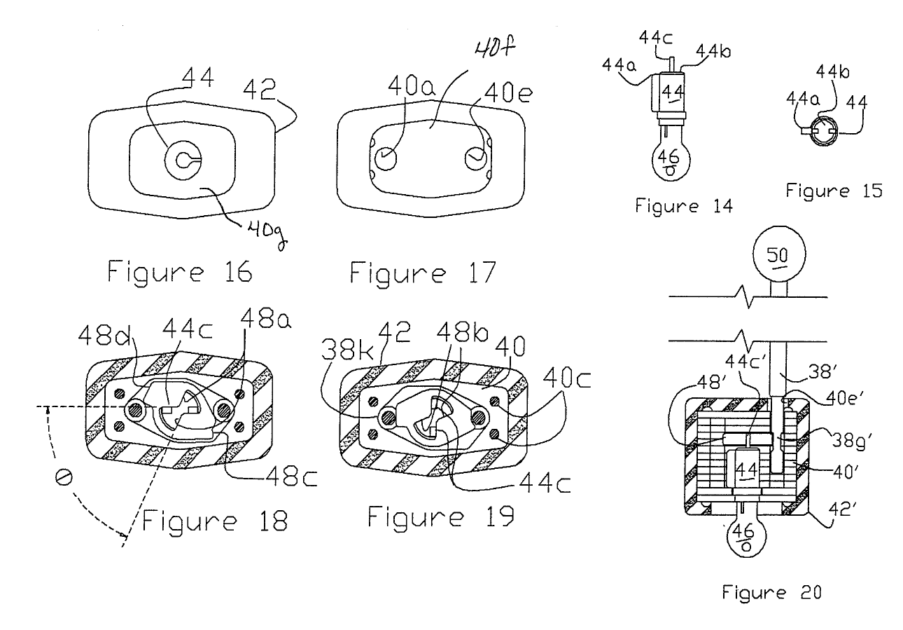

A preferred embodiment of the present invention is illustrated in FIGS. 11-20 in which the fixed end 38a of an articulated cable 38 (preferably armored) is secured within an opening 40a (FIG. 13) of a lock housing 40 by means of a sheave 40b wedged into a groove 38b. The cable is formed by metal sleeves or links made, for example, of hardened steel and formed with a convex portion 38d at one end which extends into the adjacent link to provide the articulation necessary to allow the cable to be threaded through a gun barrel, cartridge ejection chamber or magazine chamber (hereinafter collectively referred to as the “barrel”). A central twisted wire 38e extends through the links and is crimped to the fixed end and also to a free or active end 38f to join the links together. See FIG. 11. The free or active end of the cable defines an annular groove 38g (FIG. 13) formed by a reduced diameter section bounded by a lower section 38h and an upper section 38i. The junction between the reduced section and lower section 38h forms a shoulder 38k (FIG. 12) which functions in conjunction with a rotatable or pivotal cam to lock the cable free end in the housing as will be explained. A plastic sleeve or coating 38l encloses the links to prevent marring of a gun barrel, etc. The diameter of the cable is preferably small enough to be threaded through the barrel of one of the smaller guns such as a 22 caliber. A diameter of about 0.215 inches has been found to be satisfactory for this purpose.

The lock housing 40 is formed of laminations 40c, preferably made of hardened steel, secured together by rivets 40d. See FIGS. 11 and 13. The lock housing includes a blind bore 40e, defining a longitudinal axis x-x, for receiving the cable free end as is illustrated more particularly in FIGS. 11 and 12. A rubber boot 42 is fitted around the sides and a portion of the top 40f and bottom 40g of the housing. See FIGS. 16-19.

A conventional key lock cylinder 44 is mounted in a housing cavity 40e, which cavity is aligned along an axis parallel to the axis x-x. A split tumbler casing 44a functions with a key 46 to allow an inner barrel or plug 44b of the key cylinder to rotate through about a 90° angle from a locked position (FIG. 12) to the unlocked position (FIG. 11). A pair of upwardly protruding posts 44c formed integrally with the plug, engage lock and unlock actuating shoulders 48a and 48b, respectively, formed by a Figure 8-shaped opening, in a cam 48 as is illustrated in FIGS. 18 and 19. The cam 48, sometimes referred to as a locking member or actuating arm, is planar in form and lies in a plane perpendicular to the longitudinal axis. The cam terminates at one end in a slightly concave tip 48c which extends into and out of the cable free end receiving bore 40e when the plug is rotated to its locked and unlocked position, respectively. The concave shape of the tip 48c wraps around a portion of the reduced section, e.g, about 90°, of the cable free end to engage an increased area of the shoulder 38k to securely lock the cable free end in the housing as is shown in FIG. 19. The other end of the cam terminates in a tip 48d which is arranged to extend into the groove 38b in the locked position (FIGS. 12 and 19) to function along with the sheave 40b to maintain the fixed end of the cable within the lock housing. It is to be noted that the extension of the cam tip 48d into the groove in the fixed cable end is an option.

While the plug 44b rotates through a 90° angle between the unlocked (FIG. 18) and locked (FIG. 19) positions the cam rotates only through an angle θ of about 20°. This action accommodates the relatively narrow width of the lock housing.

The key lock cylinder is arranged so that the key can only be inserted and withdrawn when the plug is in the locked position, i.e., with the cam tips extending into the cable receiving bores. This ensures that the key cannot be withdrawn with the cable free end only partially inserted into the bore 40e as is illustrated in FIG. 13. The cable free end must be inserted fully, i.e., a predetermined distance, into the bore 40e before the key 46 can be removed from the lock. This arrangement greatly reduces the possibility that a user will mistakenly believe that the cable is secured to the lock housing.

Referring now to FIG. 20 a lock assembly is shown in which a cable 38′ includes a free end 38f insertable into bore 42e′ and secured therein by cam 48′ which extends into groove 38g′ in the locked position. The cam 48′ is shaped like the cam 48 except that it does not include a tip which is extendable into a groove in the cable fixed end. Instead the cable fixed or second end comprises an enlarged member 50, for example, in the form of a metal ball, to preclude the second end from passing through a gun barrel or cartridge ejection chamber. The lock housing need be provided with only one cable receiving bore. Expect for such difference the lock assembly of FIG. 20 functions in the same manner as the lock assembly of FIGS. 11-19.

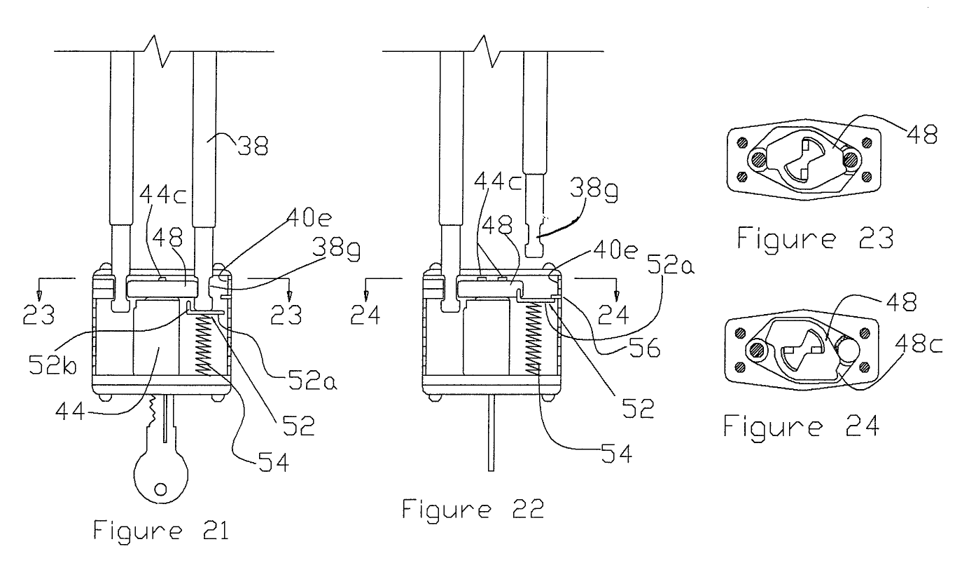

A modified lock arrangement is illustrated in FIGS. 21-24 in which an L-shaped key retaining member or plate 52 is disposed within the lock housing blind bore 40e. The plate 52 includes a planar horizontal section 52a and a vertically extending section 52b. The plate is biased in an upward direction by a compression spring 54 disposed in the bore 40e below the horizontal section. When the cable free end is inserted into the blind bore 40e a predetermined distance so that the groove 38g is opposite the cam tip 48c the cylinder lock plug can be turned to its locked position and the key removed as is shown in FIGS. 21 and 23.

In the locked position the key retaining plate is pressed downwardly compressing the spring 54 and lowering the vertical section 52b so that it is positioned below the cam or actuating arm 48 as is illustrated in FIG. 21.

When the cylinder lock plug 44b is turned to its unlocked position, via a key and the cable free end removed from the bore 40e, the plate 52 is moved upwardly by the spring 54 to the stop 56. In this position the vertical plate section 52b extends in front of the cam tip 48c thereby preventing the cylinder lock plug from rotating to its locked position.

The key retaining plate permits the key to be withdrawn only when the cable free end is locked in the lock housing.

It is to be noted that FIGS. 21-24 are merely diagrammatic views presented to illustrate the manner in which a key retaining plate may be used to ensure that the key cannot be removed in the absence of the cable free end being locked.

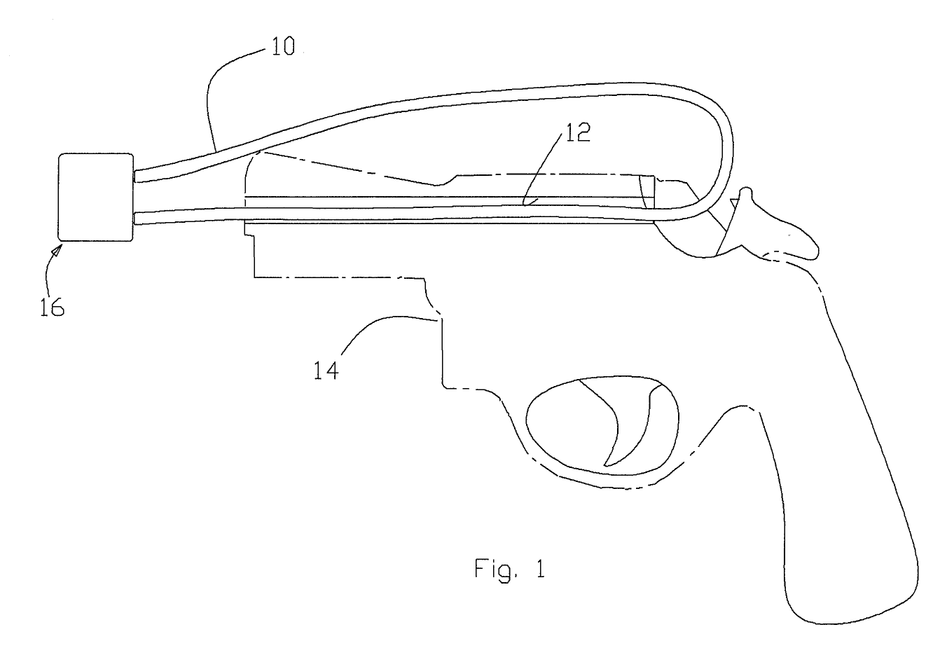

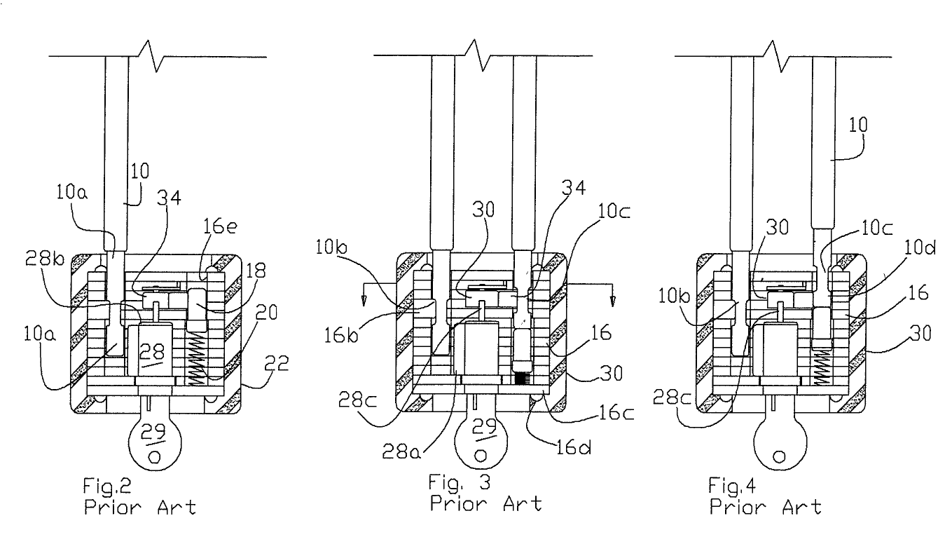

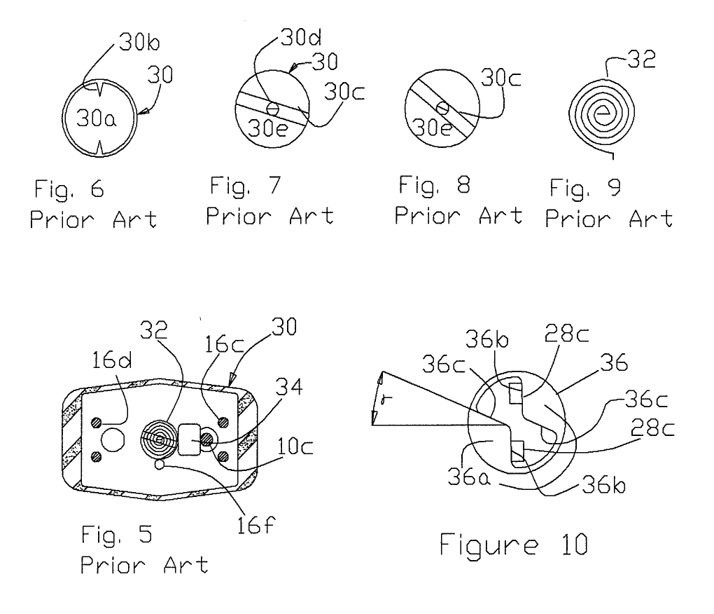

A spring biased plunger, such as item 18 of FIGS. 1-3, can be used in lieu of the key retaining plate 52 to prevent the key from being removed when the cable free end is not locked in the housing.

There has thus been described a novel, simple and inexpensive gun lock assembly which does not rely on springs to lock the cable in place and which greatly reduces the risk that an operator will only partially insert the cable free end into the lock housing, remove the key and believe that the cable is locked in place when it is not. Various modifications of the lock assembly will undoubtedly occur to those skilled in the art without involving a departure from the spirit and scope of the present invention as called for in the appended claims.

What is claimed is:

1. A lock assembly for securing firearms against unauthorized access comprising:
an elongated flexible cable having a free end adapted to be inserted into a barrel or chamber of a firearm and a second end which is not insertable through the barrel or chamber, the free end defining an annular groove;
a lock housing having a cable free end receiving bore therein;
a key lock cylinder mounted in the housing and having a rotatable plug for receiving and turning through a predetermined angle from an locked position to a unlocked position with a key; and
a locking member coupled to the cylinder and arranged for movement into and out of the bore only in response to the rotation of the plug to the locked and unlocked positions, respectively, the locking member being arranged to extend into the cable annular groove when the free end of the cable is inserted a predetermined distance into the bore and the plug is turned to the locked position to lock the free end of the cable in the lock housing.

2. The lock assembly of claim 1 wherein the annular groove is defined by upper and lower cylindrical sections of substantially one diameter separated by an intermediate section of a reduced cross-sectional dimension so that the locking member extends into the intermediate section to secure the cable free end in the housing the locked position.

3. The lock assembly of claim 2 wherein the cable receiving bore in the housing defines a longitudinal axis and the locking member is arranged to move laterally at a substantially right angle to the longitudinal axis.

4. The lock assembly of claim 3 wherein the lock cylinder is arranged so that the key is removable only when the plug is turned to the locked position.

5. The lock assembly of claim 4 wherein the lower section of the cable free end interferes with the movement of the locking member into the cable receiving bore when the cable free end is inserted into the bore a distance less than the predetermined distance to prevent removal of the key.

6. The lock assembly of claim 4 wherein the second end of the cable is secured to the lock housing.

7. The lock assembly of claim 4 wherein the second end of the cable is secured to an enlarged member separate from the lock housing.

8. The lock assembly of claim 4 wherein a protruding post is secured to the plug and wherein the locking member is a driven directly by the post.

9. The lock assembly of claim 4 wherein a protruding post is secured to the plug and the locking member is coupled to the post by a cam.

10. The lock assembly of claim 4 further including a key retaining member arranged to prevent the plug from turning to its locked position until the locking member is inserted into the groove in the cable free end.

11. The lock assembly of claim 4 wherein the key retaining member is biased into a position to prevent the plug from turning to the closed position in the absence of the cable free end being disposed within the cable receiving bore.

12. The lock assembly of claim 11 wherein the key retaining member comprises an L-shaped plate.

13. A lock assembly for securing firearms against unauthorized access comprising:
an elongated flexible cable having a free end and a second end, the free end defining an annular groove therein;
a lock housing having a first blind bore extending into the housing for receiving the free end of the cable;
a key lock cylinder mounted in the housing and having a rotatable plug for receiving and turning through a predetermined angle with a key;
the plug carrying at least one projecting post rotatable therewith; and
an actuating arm mounted in the housing for rotation with the post, the arm being arranged to extend into the blind bore and the annular groove in the free end of the cable when the plug is turned in one direction to lock the free cable end and to be withdrawn from the blind bore when the plug is turned in an opposite direction to allow the cable free end to be withdrawn from the housing.

14. The lock assembly of claim 13 wherein the plug is arranged to rotate between an unlocked position in which the actuating arm is retracted from the bore to a locked position in which the actuating arm is extended into the bore and wherein the free end of the cable includes a cylindrical stub extending below the annular groove, the stub being arranged to engage the actuating arm when the free end is not fully inserted into the blind bore and prevent the plug from turning to its locked position.

15. The lock assembly of claim 14 wherein the lock cylinder is arranged so that the key is removable only when the plug is turned to its locked position.

16. The lock assembly of claim 15 wherein the first bore defines a longitudinal axis and wherein the lock housing defines a second bore aligned parallel to the longitudinal axis with the second end of the cable secured therein, the second end of the cable including a groove and wherein the actuating arm includes first and second ends with the first and second ends being arranged to extend into the grooves in the free and second cable ends of the cable when the plug is turned to the locked position.

17. The lock assembly of claim 16 wherein the actuating arm is made of steel.

18. The lock assembly of claim 16 wherein said at least one projecting post comprises a plurality of spaced posts extending parallel to the longitudinal axis.

19. The lock assembly of claim 16 wherein the actuating arm lies in a plane substantially perpendicular to the longitudinal axis.

20. The lock assembly of claim 19 wherein the actuating arm defines a centrally disposed cavity through which the posts extend.

21. The lock assembly of claim 20 wherein the cavity forms a pair of lock and unlock actuating shoulder which are engaged by the posts when the plug of the lock cylinder is turned to its locked and unlocked positions, respectively.

22. The lock assembly of claim 21 wherein the flexible cable is armored.

23. The lock assembly of claim 16 further including a key retaining member arranged to prevent the plug from turning to its locked position until the locking member is inserted into the groove in the cable free end.

24. A firearm lock assembly for preventing the unauthorized access to a firearm comprising:
an elongated cable having a free end and a second end, the free end defining an annular grove therein;
a lock housing having a top, a bottom, a cable free end receiving blind bore, and a key lock cylinder receiving bore, the free end receiving bore defining a longitudinal axis and extending into the lock housing from the top and the cylinder lock bore extending into the lock housing from the bottom along an axis parallel to the longitudinal axis;
a key lock cylinder mounted in the cylinder lock receiving bore and having a rotatable plug for receiving and turning through a predetermined angle with a key from a locked to an unlocked position, the plug having at least one upwardly projecting post aligned parallel to the longitudinal axis;
a cam mounted for rotation in the housing and having a central opening through which said at least one post extends, the cam having a first tip arranged to be inserted into the cable free end groove when the cable free end is inserted into the free end receiving bore a predetermined distance and the plug is rotated to its locked position, the first tip being arranged to be withdrawn from the groove when the plug is rotated to its unlocked position.

25. The lock assembly of claim 24 wherein the second end of the cable is attached to an enlarged member separate from the lock housing.

26. The lock assembly of claim 24 wherein the second end of the cable is secured in the lock housing in a bore separate from the cable free end and lock cylinder receiving bores, the cable second end receiving bore extending from the top of the lock housing parallel to the longitudinal axis.

27. The lock assembly of claim 20 wherein the second cable end includes a groove and wherein the cam includes a second tip arranged to extend into the second cable end groove when the plug is rotated to its locked position.

28. The lock assembly of claim 27 wherein the lock cylinder is arranged so that the key can only be removed when the plug is in its locked position.

29. The lock assembly of claim 28 wherein said at least one protruding post comprises a plurality of posts.

30. The lock assembly of claim 24 wherein the key lock cylinder is arranged so that the key can only be removed when the plug is in the locked position and further including a key retaining plate disposed in the cable receiving bore and biased toward the top of the housing for preventing the first cam tip from extending into the cable receiving in the absence of the cable free end being inserted into the cable receiving bore said predetermined distance.
